(19) United States
(12) Patent Application Publication
(10) Pub. No.: US 2009/0218381 A1
(43) Pub. Date: Sep. 3, 2009

(54) COMBINED STAPLER AND HOLE PUNCH

(76) Inventors: Laurence Mandler Holt, Bedford (GB); Ian Benjamin Armstrong, Bedford (GB)

Correspondence Address: SNELL & WILMER LLP (OC), 600 ANTON BOULEVARD, SUITE 1400, COSTA MESA, CA, 92626, US

(21) Appl. No.: 12/066,035

(22) PCT Filed: Sep. 7, 2006
(86) PCT No.: PCT/GB2006/003322

§ 371 Date: Aug. 27, 2008

(30) Foreign Application Priority Data
Sep. 7, 2005 (GB) 0518251.4

(51) Int. Cl. B25C 5/00

(52) U.S. Cl. 227/76

(57) ABSTRACT

We provide a combined stapler and hole punch comprising a stapler part (1) having a staple magazine (3) and actuating member (4) for performing a stapling function; and a base (2) to which the stapler part is coupled. The base (2) comprises a slot (10) defined by opposed surfaces for the receipt of material to be punched therebetween and at least two bores (12) passing through the opposed surfaces of the slot (10). Each bore (12) has a punch (13) resiliently biased towards a rest position in which a punching end of the respective punch is retracted from the slot (10) and in which part of the punch (13) projects from the base (2) towards the stapler part (1). A mode device (17) is also provided which is adapted to be switchable between a stapling mode and a punching mode. When in the stapling mode, the mode device (17) permits relative movement between the actuating member (4) and the magazine (3) so as to cause a staple to be forced from the magazine (3) against the base (2). When in the punching mode, the mode device (17) prevents a staple from being ejected from the magazine (3) such that the stapler part (1) forces the punches (13) against their resilience through the slot (10) so as to punch the material.

The present invention relates to a combined stapler and hole punch which may be selectively used in either a stapling or a punching mode.

Staplers and hole punches are common pieces of office equipment and are conventionally provided as separate devices. This forces users to purchase the devices separately which increases the financial outlay. Furthermore, from an environmental perspective, two products use more materials and energy in manufacture than just one. Such items individually also occupy more desk space and are easily misplaced.

It would therefore be advantageous to have a single device which performs each of the functions of stapling and punching equally as well as the individual equivalents. Combined stapler and hole punch devices are known. U.S. Pat. No. 6,527,157, for example, discloses a stapler having a co-lateral punching function. The device takes the form of a conventional stapler, with the additional feature of a punch hole containing a biased punching plunger formed on the top surface of the base. A lever shaft on the pressing arm of the stapler allows the user to prevent a staple from being ejected when the punching operation is required. A similar multipurpose stapler-hole punch is described in U.S. Pat. No. 5,979,734. However, these devices can only punch one hole per pressing action and are therefore of little use for punching two holes in sheets of paper for filing in, for example, ring binders.

U.S. Pat. No. 4,288,018 discloses a paper fastening device which takes the form of a conventional hole punch. Two staple magazines are attached to the base and coupled to the actuating arm of the hole punch.

As in U.S. Pat. No. 4,288,018, typically the problem of providing a two hole punch combined with a stapler has been addressed by combining together staplers and hole punches of conventional construction. GB-A-2095155 discloses a hand-operated stapler-punch combination which punches two holes, wherein a punch assembly is coupled to the base of a conventional staple assembly using a hinge. Being merely an aggregate of the two separate devices, this is bulky and does not allow the user to quickly and easily select the desired stapling or punching function.

In accordance with the invention, we provide a combined stapler and hole punch comprising:—

a stapler part comprising a staple magazine and actuating member for performing a stapling function;

a base to which the stapler part is coupled, the base comprising a slot defined by opposed surfaces for the receipt of material to be punched therebetween and at least two bores passing through the opposed surfaces of the slot, each bore having a punch resiliently biased towards a rest position in which a punching end of the respective punch is retracted from the slot and in which part of the punch projects from the base towards the stapler part; and,

a mode device adapted to be switchable between a stapling mode and a punching mode, wherein when in the stapling mode, the mode device permits relative movement between the actuating member and the magazine so as to cause a staple to be forced from the magazine against the base, and when in the punching mode prevents a staple from being ejected from the magazine such that the stapler part forces the punches against their resilience through the slot so as to punch any said material therebetween.

The present invention addresses the deficiencies of the combined stapler and hole punch devices of the prior art by providing at least a two hole punch actuable by part of a stapler assembly. This gives a fully integrated device which may be no larger than a standard stapler and therefore advantageously saves space on the office desktop. In the collation of paper sheets for example, the provision of a combined device for hole-punching and stapling is of great advantage.

The stapler part may contact the punches directly so as to cause them to be forced through the slot. Alternatively the stapler part may contact an intermediate member such as a plate which in turn contacts the punches.

A mode device is provided on the combined stapler and hole punch of the present invention to enable the user to quickly and easily select the desired punching or stapling mode of operation. The combined device performs the two functions equally as well as the two separate devices of conventional form. Thus the user needs to purchase one device only, advantageously reducing the costs involved in purchasing office stationery.

It is envisaged that the combined stapler and hole punch of the present invention will be manually operated.

Typically, the mode device of the present invention is a locking device which prevents relative movement between the staple magazine and the actuating member when in the punching mode. This prevents a staple from being ejected from the staple magazine when the punching operation is required, thereby avoiding unnecessary wastage of staples. This also acts as a safety feature, reducing the risk of unintentional staple release.

The locking device may comprise a moveable stopper, which is switchable between a stapling mode position and a punching mode position such that when in the punching mode position the stopper makes contact with the staple magazine and prevents the relative movement between the staple magazine and actuating member. In an alternative example it may be operable to block the exit of a staple from the magazine. Preferably, the stopper is rotatable and may be rotated between a stapling mode position and a punching mode position.

In a further alternative, the device, such as a blade, which ejects the staples, may be moveable to and from an ejection position.

The locking device is preferably held in its stapling and/or punching mode by a spring or lug. The resilience of the spring means that an external force must be applied to switch the device between its two modes. Preferably, the locking device comprises an external lever to which this force can be applied. Alternatively, the actuating member is elongate and the locking device comprises an external switch which is moveable between a front and a rear position in a direction substantially parallel to the direction of elongation. The movement of the switch between these two positions is typically coupled to the rotation of a stopper within the actuating member between a stapling mode position and a punching mode position.

In this embodiment, preferably the mode device comprises a selector plate moveable to and fro in a direction substantially parallel to the direction of elongation, a stopper plate and a track. The selector plate may be integral with the external switch. Preferably, one part of the stopper plate is pivoted to the selector plate and another part is engaged with the track, such that movement of the selector plate causes the stopper plate to move in cooperation with the track between the stapling mode in which the stopper plate is orientated substantially parallel to the selector plate, and the punching mode in which the stopper plate is orientated substantially normal to the selector plate.

Typically, this preferred embodiment further comprises a retaining device adapted to retain the selector plate in one of the two positions corresponding to the stopper plate being in either the punching mode or the stapling mode.

Other external switching devices may be envisaged, such as buttons.

In general, the base and magazine of the combined stapler and hole punch of the present invention are each elongate in a common direction. The punches are preferably arranged so as to define a line and the slot preferably extends fully through the base in a direction parallel to the line defined by the punches. Typically, the common direction is substantially parallel to the line defined by the punches. This provides for a compact device with a large staple magazine capacity and advantageously provides a slot into which, for example, sheets of paper to be punched can be inserted. The sheets are aligned substantially parallel to the line defined by the punches by abutting an internal side of the slot, thereby giving holes equidistant from the edge of the paper when the device in its punching mode is actuated.

The base is preferably of substantially uniform thickness along its entire length. However, the base may alternatively have variable thickness, typically having a greater thickness at its end closer to the pivot.

Preferably, when in the punching mode the projecting parts of at least one of the punches is contacted by the staple magazine. External force applied to the actuating member then acts to force the or each punch against their resilience, through the slot, so as to punch any material therebetween. Preferably, all punches are contacted by the staple magazine, but alternatively some may be contacted by the actuating member if the staple magazine does not extend across the whole line defined by the punches.

The stapler part of the combined stapler and hole punch of the present invention is typically coupled to the base through a pivot. This allows the staple part to act as a lever to which external force to actuate the stapling and punching functions may be applied. Alternatively, the staple magazine may be coupled to the actuating member and the actuating member coupled to the base. When the staple part is coupled to the base in either of these manners, the punch nearest the pivot may project further towards the stapler part than one or more of the punches further away from the pivot. Preferably, the punches project by a distance inversely related to their distance from the pivot. This feature advantageously allows the stapling part to make contact with all of the punches simultaneously, when the actuating member is depressed.

Alternatively, the punches may project the same distance from the base. In this case the punch nearest the pivot will generally be contacted first by the stapling part when the actuating member is depressed, particularly in the case where the base is of greater thickness at its end closer to the pivot.

The biasing of the punch nearest the pivot of the combined stapler and hole punch is typically greater than that of the punch or punches further away from the pivot. This ensures that an equal force is applied to each punch when the actuating member is depressed in the punching mode, ensuring that each punch is driven fully through the slot.

In general, the ends of the projecting parts of the punches will be formed as flat/rounded surfaces with the parts projecting substantially normal to the base. This is in contrast to the punching end of the punches, which preferably have a curved or sharpened edge to ensure a clean punching motion through the material inserted into the slot.

The punches are typically resiliently biased in their bores by means of a spring, such as a coil spring.

The most common use of a hole punch is to punch two holes in a sheet of A4 paper. The combined stapler and hole punch according to the present invention preferably therefore contains two punches. These are preferably spaced at the distance required for filing sheets in a ringbinder. Alternatively, the device may contain more than two punches, typically three or four spaced at equal internals along the length of the base.

When using a hole punch it is desirable to be able to collect the waste punchings. Accordingly, the combined stapler and hole punch preferably further comprises a fully or partially detachable holder attached to the base for receiving waste punchings.

The combined stapler and hole punch of the present invention preferably contains an integral paper-positioning guide. This may be slidably mounted in the base and advantageously allows the user to punch correctly-spaced holes through the material inserted in the slot.

Whilst the punches are actuated by the stapler part upon application of external force when in the punching mode, when the device is in the stapling mode, the stapler part operates similarly to a conventional stapler. Many conventional stapler designs are contemplated for use as the stapler part provided such a part is moveable so as to actuate the punches. It will be appreciated that the stapler and punches may be adapted to respectively staple and punch a number of different materials including paper and card.

Some examples of a combined stapler and hole punch according to the invention are now described with reference to the accompanying drawings, in which:—

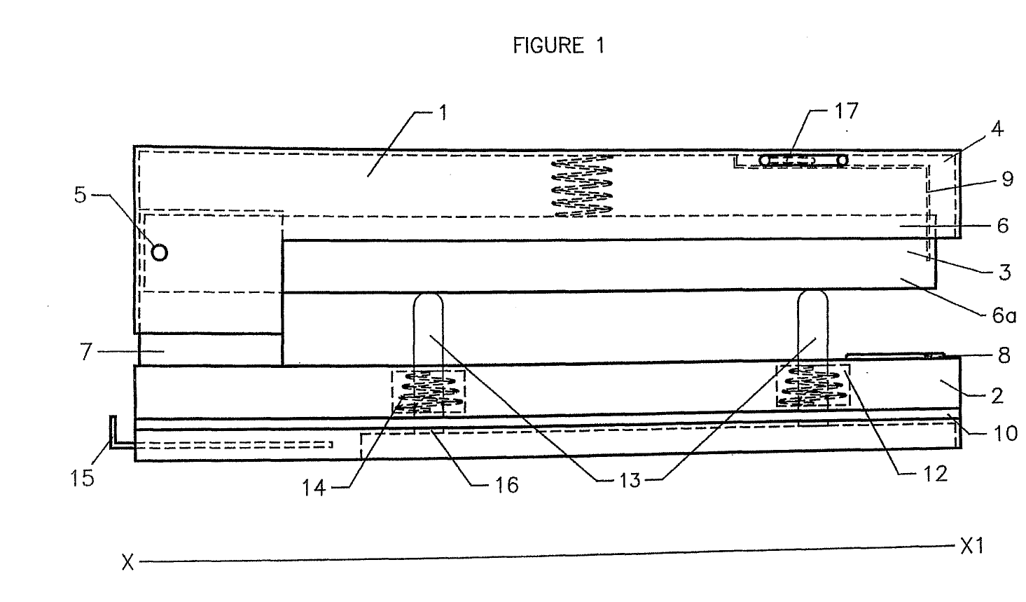

FIG. 1 is a schematic side view partly transparent in section of an example combined stapler and hole punch when in the stapling mode;

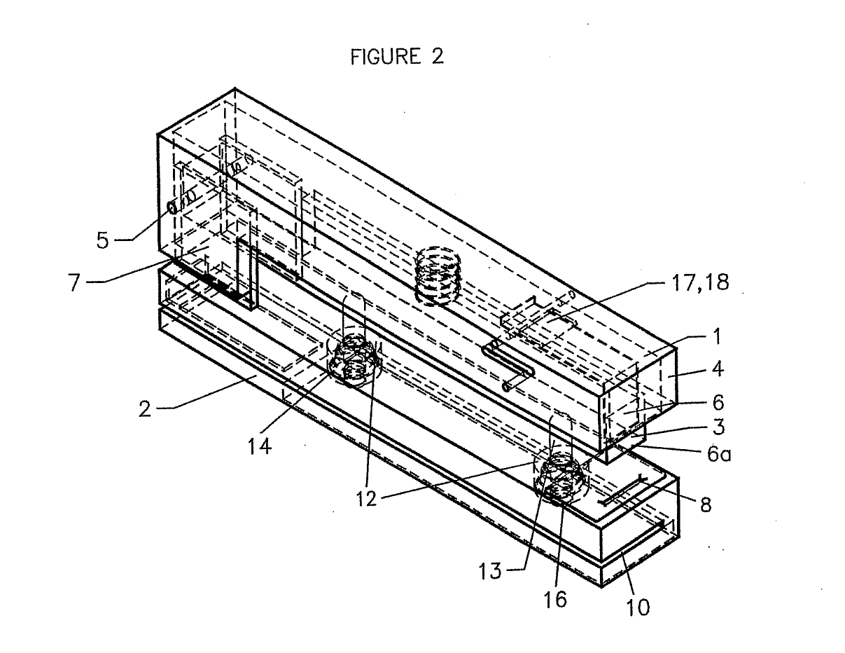

FIG. 2 is a perspective view, partly transparent, of a combined stapler and hole punch according to this example;

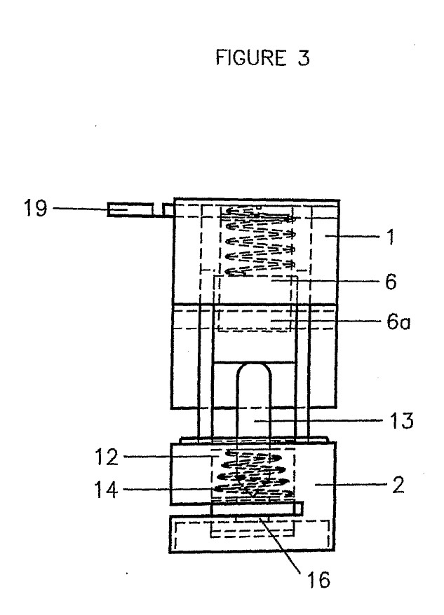

FIG. 3 is the front view of the device partly in transparent section looking along the direction X-X′ in FIG. 1;

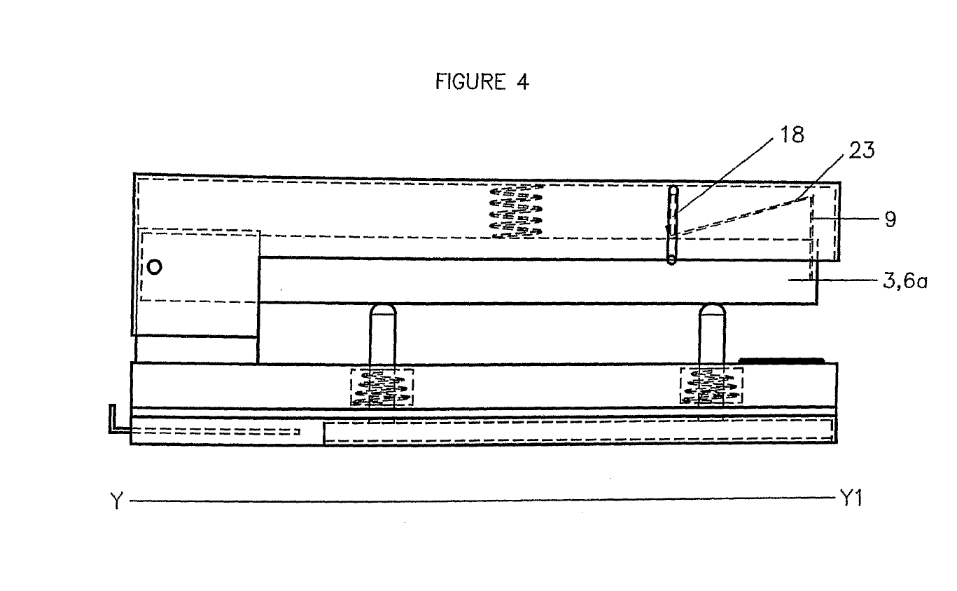

FIG. 4 is a further schematic side view partly in transparent section of a combined stapler and hole punch according to the example of the stapler in the punching mode;

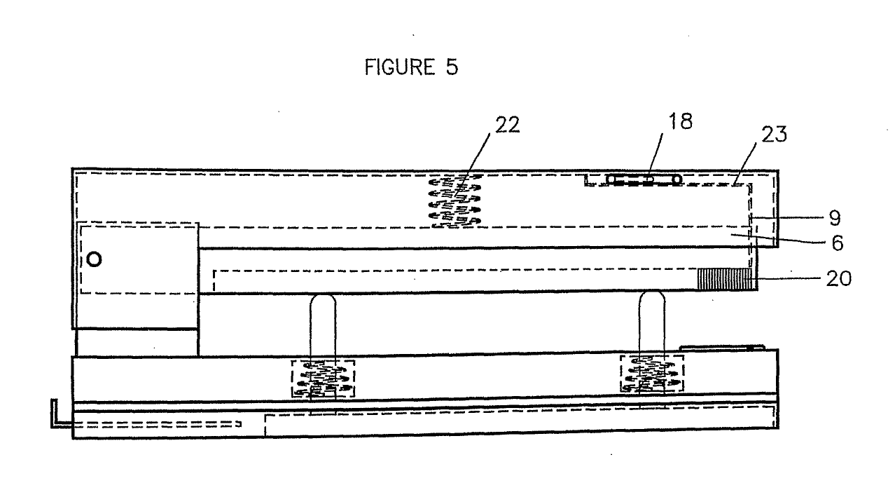

FIG. 5 is a schematic part section through the staple part according to the example in the stapling mode shown from the side;

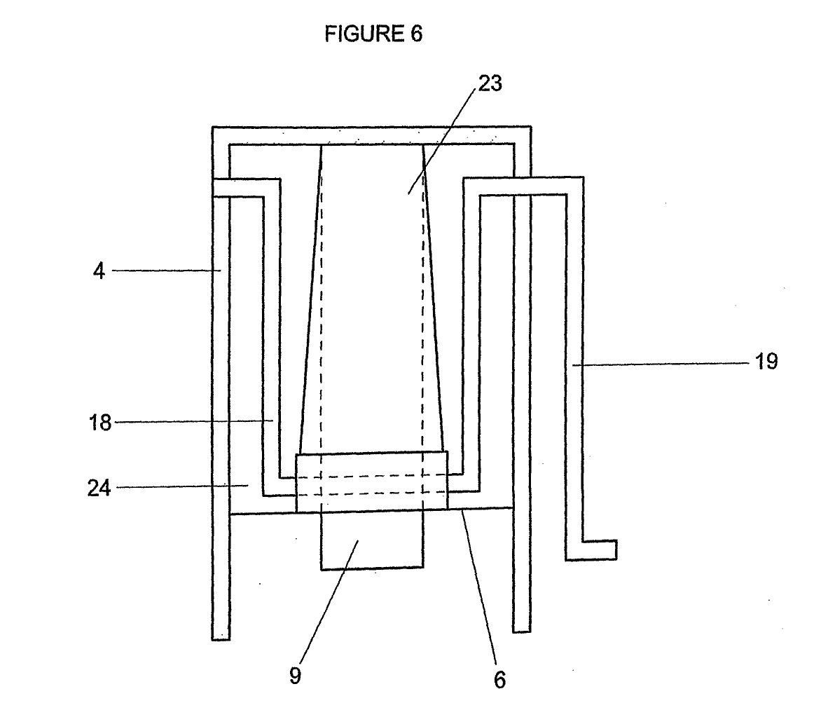

FIG. 6 shows, partly in cross-section, the staple part looking along the direction Y-Y′ in FIG. 4;

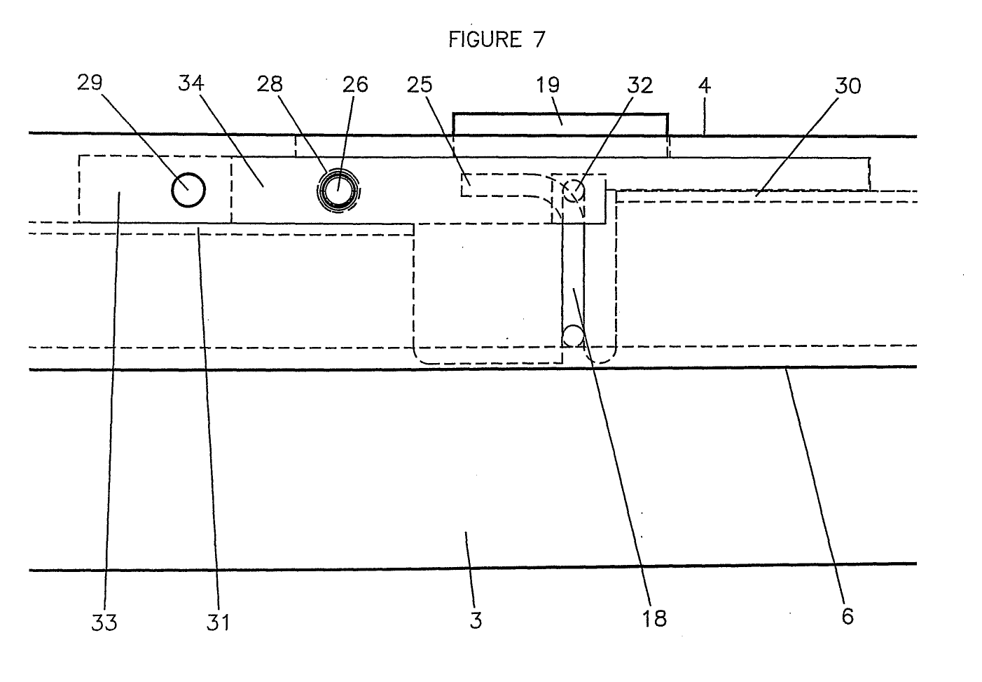

FIG. 7 shows an example mode device in transparent section in the punching mode from the side;

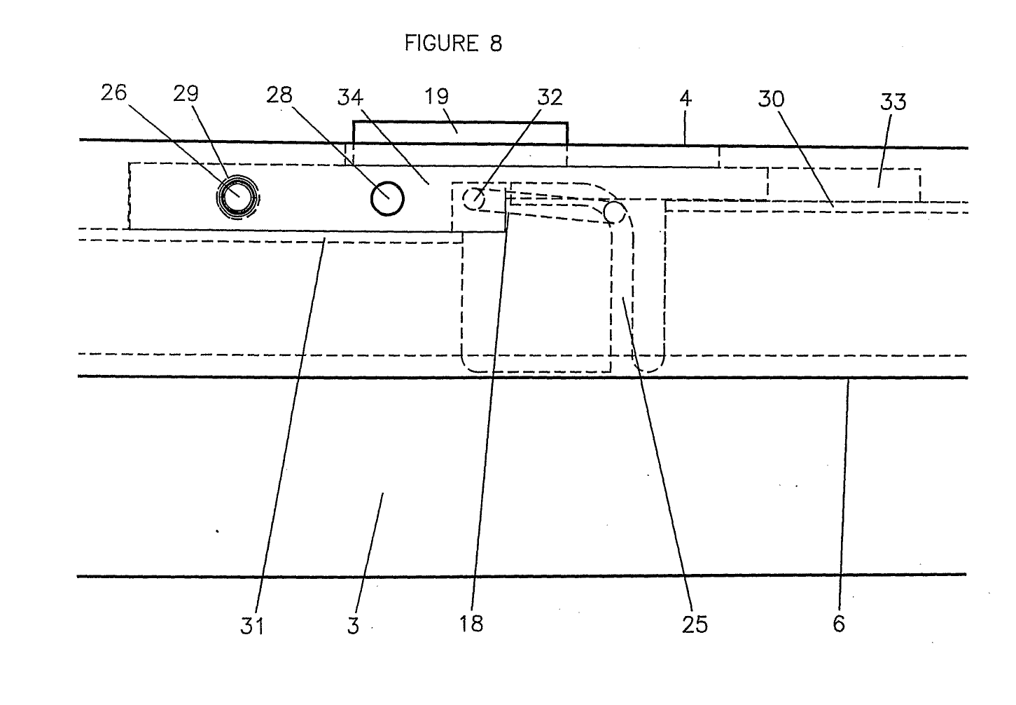

FIG. 8 shows an example mode device in transparent section in the stapling mode from the side; and

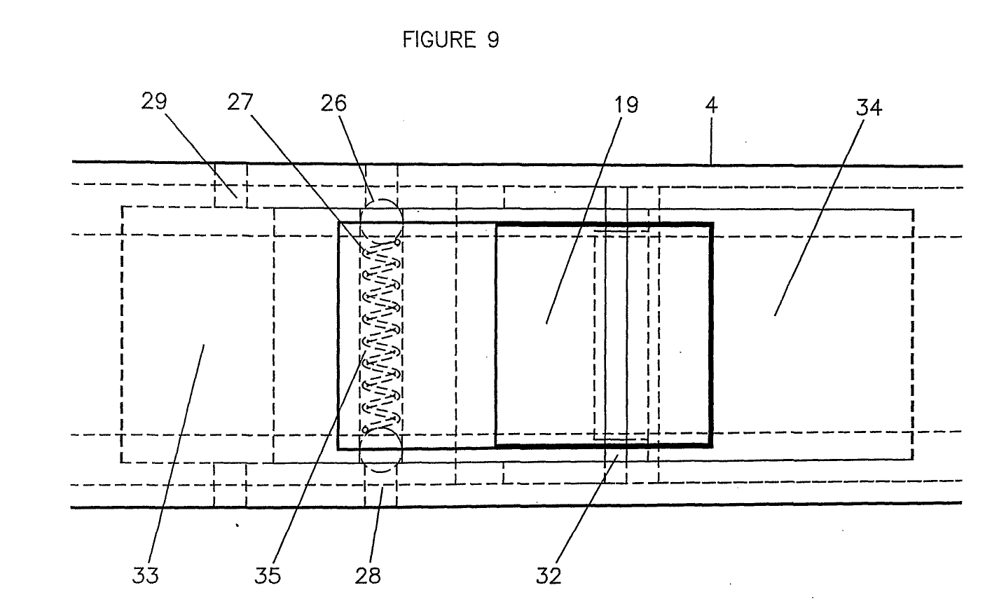

FIG. 9 is the mode device in FIG. 7 in plan view.

FIG. 1 shows a combined stapler and hole punch comprising a stapler part 1 and a base 2. The stapler part 1 comprises an elongate stapler magazine 3 and an elongate actuating member 4 in the form of an outer housing. The stapler part 1 is pivoted to the base 2 about a pin 5. The pin 5 passes through a support 7 which is mounted on the rear end of the base 2, as shown directed to the left in FIG. 1. A spring near the pivot (not shown) biases the stapler part away from the base.

The stapler part 1 takes the form of the top part of a conventional stapler. As shown most clearly in FIG. 2, a staple plate 8 is provided on the front end of the base 2, shown here at the right of FIG. 2, to act as an anvil against which the staple is deformed during stapling. The staple plate may be detachable and/or rotatable to alter the deformation of the staple during stapling. A detachable staple plate may take the form of a U-shaped member which may be affixed to the front end of the base 2. This may advantageously allow for reverse stapling in addition to conventional stapling wherein the ends of the staple are folded back along the body of the staple.

The staple magazine 3 comprises an upper channel 6 and a lower channel 6a into which the upper channel fits, both of which are pivoted about the support 7. In the rear section of the lower channel 6a of the staple magazine 3, a coil spring (not shown) is provided to force a staple pusher against a row of staples (not shown) so as to ensure staples are provided to the correct position for ejection. Returning to FIG. 1, directly above the front most staple is a staple blade 9 affixed to the internal roof of the actuating member 4, both being directly aligned above the staple plate 8.

The base 2 comprises a slot 10 defined by upper and lower opposed surfaces and which runs along its entire elongate length as shown in the FIGS. 1 and 2. The slot also extends partly through the base, normal to the direction of elongation. The slot 10 is advantageously of a sufficient thickness to allow several sheets of material, such as paper, to be inserted therein.

Two cylindrical bores 12 pass through each of the opposed surfaces of the slot 10. The bores also each pass out of a top surface of the base (towards the stapler part) and out of a bottom recessed surface of the base, the slot being located between these top and bottom surfaces. Each bore 12 has a punch 13 resiliently mounted therein by means of an internal coil spring 14 provided in an upper part of the base 2 above the slot 10. The punches 13 are biased by the springs 14 to a rest position in which their punching ends are retracted from the slot 10. The lower end of each bore terminates in a punch aperture 16 provided in the recessed lower surface of the base. This is shown more clearly in FIG. 3, which shows the combined stapler and hole punch along the direction X-X′ in FIG. 1.

An upper rounded end of each punch 13 projects from the base 2 towards the staple part 1. In this example, the staple magazine extends along the entire length of the actuating member 4 and both are pivoted to the base 2 about the pin 5. Thus both punches 13 project towards the staple magazine 3 and in this case are shown to be making contact with it in FIG. 1. Although in FIG. 1 neither of the punches is obscured from view when viewing the example combined stapler and hole punch, an alternative example would have the punch closest to the pivot either entirely or partially obscured from view by the support 7.

FIG. 1 shows a positioning guide 15 slidably mounted into the rear end of the base 2. This may be retracted to a required position to guide the depth of insertion so as to correctly locate the material in the X-X direction with respect to the punches 13.

A key feature of the present invention is the ability to switch the device between a stapling and a punching mode. FIGS. 1, 2 and 4 show the position of a locking device 17 (mode device) comprising a rotatable stopper 18 which is rotatably coupled to the actuating member 4. The rotatable stopper 18, when in the stapling mode, lies parallel to the surface defined by the roof of the actuating member 4 as shown in FIGS. 1 and 2. FIG. 4 shows the locking device in its punching mode, wherein the rotatable stopper 18 lies approximately perpendicular to the direction defined by the roof of the actuating member 4 so as to prevent the staple magazine 3 from moving towards the actuating member 4. An external lever 19 (shown in FIG. 3) is provided to allow manual control of the position of the stopper 18.

FIG. 5 is a section through the staple part according to the example when the device is in its stapling mode (with the locking device parallel to the roof of the actuating member 4).

The staple blade 9 projects from the upper roof of the actuating member 4 towards the first staple in the block 20 in the magazine 3. The upper channel 6 of the staple magazine 3 is biased away from the actuating member 4 by means of a coil spring 22 linking the roof of the actuating member 4 with the staple magazine 3.

The rotatable stopper 18 is shown parallel to the direction of the roof of the actuating member and is held in this position by means of a leaf spring 23, which is biased towards this rest position. The leaf spring 23 is also affixed to the roof of the actuating member 4 at one end and to the staple blade 9 at its other end. The leaf spring and staple blade may be an integral unit.

FIG. 4 shows the same device in the punching mode. The rotatable stopper 18 now lies perpendicular to the roof of the actuating member 4 and makes contact with the upper channel 6 of the staple magazine 3. The leaf spring 23 is biased downwards away from its resting position, and is hooked under the lower end of the rotatable stopper 18, providing resistance which prevents the stopper from swinging away from its vertical position.

FIG. 6 shows the view along Y-Y′ of the device in FIG. 4 exemplified in its punching mode. A transverse section of the stapler part is illustrated. The rotatable stopper 18 is shown to be a U-shaped member within a cavity 24 defined by the walls of the actuating member 4 and the roof of the upper channel 6 of the staple magazine 3. The external plate 19 is shown on the right hand side of FIG. 7, also in a vertical position in this punching mode. The leaf spring 23 is shown in perspective with an end hooked under the rotatable stopper 18.

FIG. 7 shows an alternative mode device to that illustrated in FIGS. 1-6. The mode device is shown in the punching mode position wherein the rotatable stopper 18 lies perpendicular (“vertically”) to the surface defined by the roof of actuating member 4. The rotatable stopper 18 comprises a plate pivoted at one end. The rotatable stopper 18 is connected through pivot 32 to a selector plate 34 which is slidably mounted in a channel 33, which runs parallel (“horizontally”) to the surface defined by the roof of actuating member 4. Selector plate 34 is affixed to external switch 19 although both may be provided as an integral unit.

Retaining plates 30 and 31 lie between selector plate 34 and the upper channel of the staple magazine 6 and hold the selector plate in place.

The end of rotatable stopper 18 which lies distal from pivot 32 rests in a track 25 which comprises a horizontal portion curving into a vertical portion.

The track 25 enables the horizontal motion of selector plate 34 moving along the track 33 to be converted into vertical motion of the distal end of rotatable stopper 18.

As is more clearly illustrated in FIG. 9, the elongate side walls of the channel 33 within actuating member 4 comprise two sets of recess (28, 29). Each set consists of two horizontally opposed recesses positioned along each wall equidistant from pivot 5 as indicated in FIG. 1 and the roof of actuating member 4. The rear of the selector plate 34 comprises a channel 35 running perpendicular to the direction defined by the elongate length of plate 34 and entirely through said plate 34. Channel 35 houses a coil spring 27 stoppered at each end by bearings 26. In FIGS. 7 and 9 the bearings 26 are shown resiliently biased towards a resting position in the front set of indents 28.

FIG. 8 shows the same mode device as in FIGS. 7 and 9 in the stapling mode. The rotatable stopper plate 18 now lies parallel to the surface defined by the roof of the actuating member 4 and rests below and substantially parallel to the front of selector plate 34. The selector plate lies to the rear of channel 33 and the bearings 26 are resiliently biased towards a resting position in the rear set of indents 29.

A method of operating the device illustrated in FIGS. 1-6 above is now described.

With reference to FIGS. 1-3, when the example combined stapler and hole punch according to the present invention is in the stapler mode, the device operates in the same way as a conventional stapler. Specifically, the rotatable stopper 18 is positioned parallel to the direction of the roof of the actuating member 4 by means of rotating the external lever 19 to a horizontal position. The stopper 18 is biased into this rest position by the leaf spring 23.

To perform the stapling function the actuating member 4 is depressed and the actuating member 4 and magazine 3 move together towards the base until the magazine contacts the material being stapled. Upon further depression the actuating member 4 moved towards the magazine 3 against the biasing force of the spring 22. The staple blade 9 then contacts the foremost staple in the magazine 3. Further depression causes a staple to be ejected from the magazine, forced through the intervening material and pinched by the geometry of the staple plate 8. The spring 22 returns the staple magazine 3 to its rest position after each stapling operation.

Returning to FIGS. 4 and 6, when the device is to be used in its punching mode the external lever 19 should be rotated to its vertical position. Such rotation requires application of force to urge the leaf spring 23 against its resilience. In this mode the rotatable stopper 18 is rotated to a position in which it lies perpendicular to the roof of the actuating member 4. The lower end of the rotatable stopper 18, together with the leaf spring 23 make contact with the upper channel 6 of the staple magazine 3. This prevents the relative movement between the staple magazine 3 and the actuating member 4 when the actuating member is depressed. Consequently, the staple blade 9 is unable to make sufficient contact with the foremost staple in the staple magazine 3 and no staple is ejected.

The method of operating the mode device in FIGS. 7-9 is different to the mode device illustrated in FIGS. 1-6. The mode device shown in FIGS. 7-9 comprises an external switch 19 moveable in a plane defined by the elongate dimension of the actuating member. When the example combined stapler and hole punch comprising this mode device is in the stapler mode, the rotatable stopper 18 is positioned parallel to the direction of the roof of the actuating member 4 by means of sliding the external switch 19 to the left of the combined stapler and hole punch in the view shown in FIG. 8. The sideways movement of the external switch 19 is coupled to the rotation of the rotatable stopper 18 about the pivot 32 from a position in which the body of the rotatable stopper plate is perpendicular to the direction defined by the roof of the actuating member 4 (punching mode) to the parallel position (stapling mode).

In contrast to the mode device illustrated in FIGS. 1-6, this second example of the mode device is not attached to a leaf spring. The rotatable stopper 18 is biased into its two extreme positions by means of a coil spring 27 housed within a channel 35 in selector plate 34. In the stapling mode the mode selector bearings 26 are held within a rear set of indents 29 by the resilience of the coil spring 27.

To convert the combined stapler and hole punch into the punching mode, the external switch 19 is moved to the right of the combined stapler and hole punch as shown in FIG. 7. Application of force to slide the external switch 19 along the roof of the actuating member 4 and the selector plate 34 along channel 33 overcomes the resilience of coil spring 27. The bearings are forced inwards and released from the rear set of indents 29. External switch 19 reaches the front end of channel 33 the mode selector bearings align with a front set of indents 29 and are held within these by the resilience of coil spring 27.

With reference to FIGS. 4 and 7, when the body of rotatable stopper 18 lies perpendicular to the roof of the actuating member 4 the far end of the stopper makes contact with the upper channel 6 of the staple magazine 3. This prevents the relative movement between the staple magazine 3 and the actuating member 4 when the actuating member is depressed. As a result, the staple blade 9 is unable to make sufficient contact with the foremost staple in the staple magazine 3 and no staple is ejected.

The punching operation of the combined stapler and hole punch is actuated in either mode, but the device is preferably utilised as a hole punch only when in the punching mode so as to prevent staple ejection. In this case, with reference to FIGS. 1-6, when the actuating member 4 is depressed, the staple magazine 3 is driven towards the base 2 about the pivot pin 5. The staple magazine makes contact with the upper ends of the projecting parts of the punches 13 and drives them against their resilience (provided by their respective springs 14) into the bores 12. As further downwards force is applied to the actuating member 4, the punches are driven through the slot 10, so as to punch two holes in any material inserted therein. Once driven through the slot 10, each punch 13 passes through its respective punch aperture 16 to eject the punched material. The punches are fully driven through the slot 10 when no further downwards force can be applied to the actuating member 4, that is, when the front of the staple magazine 3 makes contact with the staple plate 8.

Due to the resilient mounting of the punches 13 in the bores 12 using the springs 14, when the punching operation is complete and the downwards force applied to the actuating member 4 is released, the punches retract to their rest positions clear of the slot 10.

The waste punchings, having been driven through the punch apertures 16 are collected in a holder (not shown in the Figures) affixed to the underside of the base 2. The holder may clip on to the underside of the base and be completely removable. Alternatively, it may be hingeably attached to the base. When the holder becomes full, it is fully or partially detached from the base and emptied for further use.

1. A combined stapler and hole punch comprising:
a stapler part comprising a staple magazine and actuating member for performing a stapling function;
a base to which the stapler part is coupled, the base comprising a slot defined by opposed surfaces for the receipt of material to be punched therebetween and at least two bores passing through the opposed surfaces of the slot, each bore having a punch resiliently biased towards a rest position in which a punching end of the respective punch is retracted from the slot and in which part of the punch projects from the base towards the stapler part; and
a mode device adapted to be switchable between a stapling mode and a punching mode, wherein when in the stapling mode, the mode device permits relative movement between the actuating member and the magazine so as to cause a staple to be forced from the magazine against the base, and when in the punching mode prevents a staple from being ejected from the magazine such that the stapler part forces the punches against their resilience through the slot so as to punch any said material therebetween.

2. A combined stapler and hole punch according to claim 1 wherein mode device is a locking device which, when in the punching mode, prevents relative movement between the staple magazine and the actuating member.

3. A combined stapler and hole punch according to claim 2 wherein the locking device comprises a moveable stopper, which is switchable between a stapling mode position and a punching mode position such that when in the punching mode position the stopper makes contact with the staple magazine and prevents the relative movement between the staple magazine and the actuating member.

4. A combined stapler and hole punch according to claim 3 wherein the stopper is rotatable between a stapling mode position and a punching mode position.

5. A combined stapler and hole punch according to claim 1 wherein the mode device comprises an external lever to switch the locking device between said stapling and said punching mode.

6. A combined stapler and hole punch according to claim 1, wherein the mode device comprises an external switch which is moveable in a direction substantially parallel to the direction of elongation of the actuating member to switch the locking device between said stapling and said punching mode.

7. A combined stapler and hole punch according to claim 6, wherein the mode device comprises a selector plate and another part is engaged with the track, such that movement of the selector plate causes the stopper plate to move in cooperation with the track between the stapling mode in which the stopper plate is orientated substantially parallel to the selector plate and the punching mode in which the stopper plate is orientated substantially normal to the selector plate.

8-25. (canceled)

26. A combined stapler and hole punch according to claim 7, further comprising a retaining device adapted to retain the selector plate in one of two positions corresponding to the stopper plate being in either the punching or the stapling mode.

27. A combined stapler and hole punch according to claim 1, wherein the base and magazine are each elongate in a common direction.

28. A combined stapler and hole punch according to claim 1, wherein the punches are arranged so as to define a line and wherein the slot extends fully through the base in a direction parallel to the line defined by the punches.

29. A combined stapler and hole punch according to claim 1, wherein when in the punching mode the projecting parts of at least one of the punches is contacted by the staple magazine.

30. A combined stapler and hole punch according to claim 1, wherein the stapler part is coupled to the base through a pivot, wherein the punches are arranged at increasing distances from the pivot, wherein the punch nearest the pivot projects further towards the stapler part than one or more of the punches further away from the pivot.

31. A combined stapler and hole punch according to claim 30, wherein the punches project by a distance inversely related to their distance from the pivot.

32. A combined stapler and hole punch according to claim 30, wherein the biasing of the punch nearest the pivot is greater than that of the punch or punches further away from the pivot.

33. A combined stapler and hole punch according to claim 1, wherein the punches are resiliently biased in their bores by means of a spring.

34. A combined stapler and hole punch according to claim 1, wherein there are two punches.

35. A combined stapler and hole punch according to claim 1, further comprising a fully or partially detachable holder attached to the base for receiving waste punchings.

36. A combined stapler and hole punch according to claim 1, wherein in the punching mode the stapler part contacts the projecting parts of the punches so as to force them through the slot.
